(19) United States
(12) Patent Application Publication
(10) Pub. No.: US 2006/0078368 A1
(43) Pub. Date: Apr. 13, 2006

(54) Telescopic tube assembly for a clothes rack

(76) Inventor: Chi-Chung Wang, Daliao Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/963,449

(22) Filed: Oct. 13, 2004

(51) Int. Cl. F16B 7/10

(52) U.S. Cl. 403/109.1

(57) ABSTRACT

A telescopic tube assembly includes an outer tube, an inner tube slidably received in the outer tube, an abutting device provided under the bottom cap and having a first flange, a first conical abutting face formed on top of the first flange, a hollow cylinder formed on top of the first conical abutting face and a first through hole defined through the hollow cylinder, and a drive rod extending into a second through hole in a stop. The drive rod has a second conical abutting selectively engaged with the first conical abutting face of the abutting device such that movement of the stop is able to selectively expand the first conical abutting face to allow the first flange to abut the inner periphery of the outer tube to position the inner tube relative to the outer tube.

### BACKGROUND OF THE INVENTION

1. Field of the Invention

The present invention relates to a telescopic tube assembly, and more particularly to a telescopic tube assembly for a clothes rack to enable the clothes rack user to easily adjust the height of the clothes rack.

2. Description of Related Art

A conventional clothes rack has two telescopic tube assemblies, and a crossbar respectively and securely connected to proximal ends of the two telescopic tube assemblies. Each telescopic tube assembly has an inner tube and an outer tube having the inner tube slidably received inside the outer tube via a positioning device which is mounted around the inner tube. The positioning device for positioning the inner tube inside the outer tube may be a boss eccentrically formed on an outer periphery of the inner tube to abut an inner periphery of the outer tube such that when the boss abuts the inner periphery of the outer tube, the inner tube is positioned relative to the outer tube. However, the positioning effect between the inner tube and the outer tube is not as good as expected. Because the positioning force between the inner tube and the outer tube relies only on the friction force between the boss and the inner periphery of the outer tube, the inner tube's sliding movement relative to the outer tube may not be linear especially when the boss is not fully disengaged with the inner periphery of the outer tube. That is, the inner tube's movement inside the outer tube may not be smooth due to the possible inclination of the inner tube relative to the outer tube.

To overcome the shortcomings, the present invention tends to provide an improved telescopic tube assembly for a clothes rack to mitigate the aforementioned problems.

### SUMMARY OF THE INVENTION

The primary objective of the present invention is to provide an improved telescopic tube assembly for a clothes rack. The telescopic tube assembly is able to enable the clothes rack user to easily adjust the clothes rack height.

A different objective of the present invention is that the telescopic tube assembly is able to provide a uniform friction force between the inner tube and the outer tube so that the movement of the inner tube relative to the outer tube is smooth.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the telescopic tube assembly of the present invention;

FIG. 2 is a cross sectional view showing the combination of the telescopic tube assembly in FIG. 1;

FIGS. 3 and 4 are schematic views showing the movement of the telescopic tube assembly of the present invention;

FIG. 5 is a schematic view showing the application of the telescopic tube assembly of the present invention with a clothes rack;

FIG. 6 is an exploded perspective view of a second embodiment of the present invention; and

FIG. 7 is an exploded perspective view of a third embodiment of the present invention.

### DETAILED DESCRIPTION OF THE PREFERRED EMBODIMENT

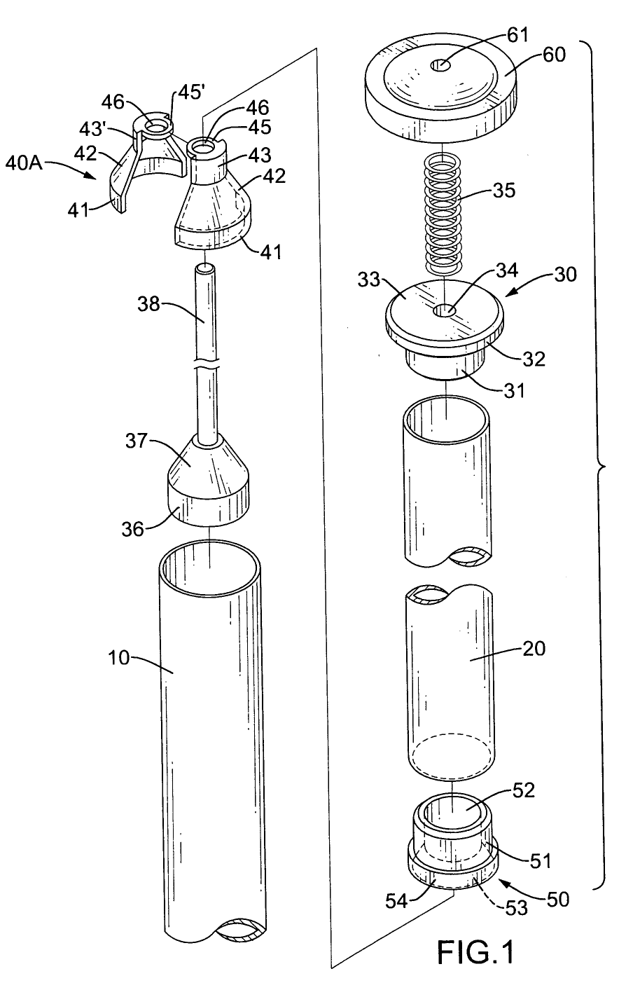

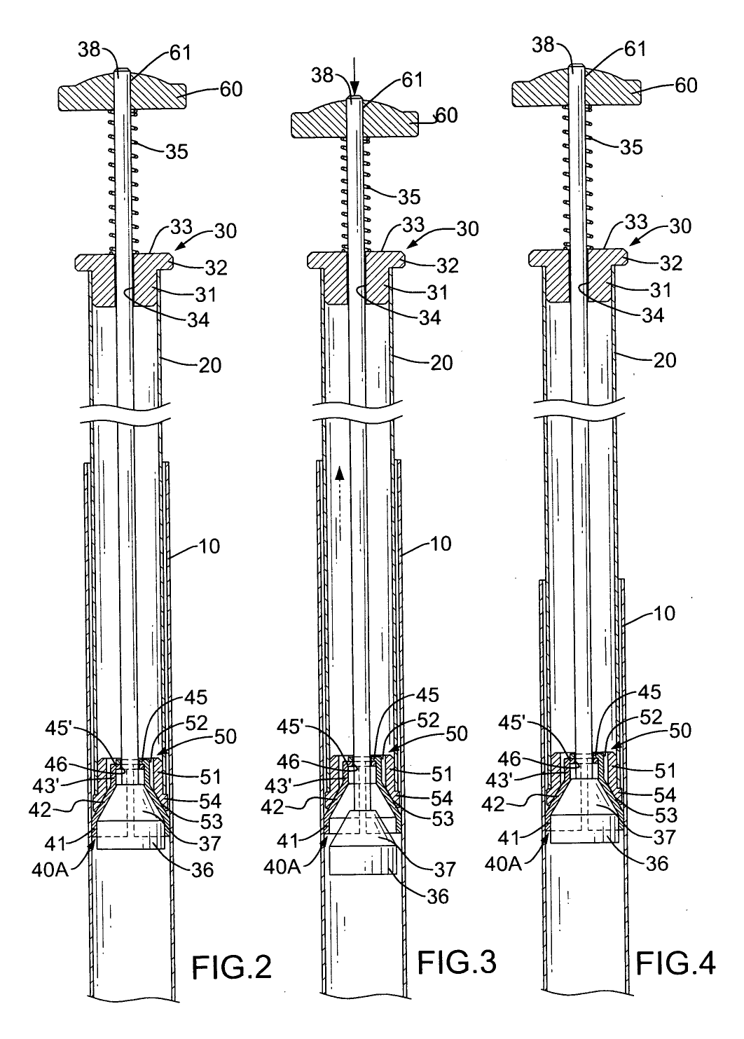

With reference to FIGS. 1 and 2, the telescopic tube assembly in accordance with the present invention includes an outer tube (10) with a top open end and an inner tube (20) slidably received inside the outer tube (10) and having two open ends.

A top cap (30) is provided to close the top open end of the inner tube (20) and has an annular skirt (31) integrally extending from a circular disk (33), a first flange (32) formed on an outer peripheral edge of the circular disk (33) and a first through hole (34) centrally defined through the circular disk (33).

A bottom cap (50) is provided to close the bottom open end of the inner tube (20) and has a tubular extension (51), a second through hole (52) defined through the tubular extension (51) to correspond to and align with the first through hole (34) of the top cap (30), a first conical abutting face (53) formed on a bottom inner face of the tubular extension (51) and a second flange (54) formed on an outer peripheral edge of the bottom cap (50).

A stop (60) is provided on top of the top cap (30) to sandwich a recoil force providing device (35) with the top cap (30) and has a third through hole (61) defined to align with the first through hole (34) of the top cap (30). In this preferred embodiment, the recoil force providing device is a helical spring (35).

An abutting device (40A) is provided under the bottom cap (50) and has two halves. Each half of the abutting device (40A) is provided with a third flange (41), a second conical abutting face (42) to correspond to the first conical abutting face (53) of the bottom cap (50), a sectorial face (43,43′) extending upward from the second conical abutting face (42), an ear (45,45′) horizontally extending from an inner face on a top portion of the sectorial face (43) and a fourth through hole (46) defined through the ear (45,45′) to correspond to the second through hole (52) of the bottom cap (50). It is noted that the two sectorial faces (43,43′) respectively have a height different from the other. Accordingly the ears (45,45′) are respectively located at different positions in relation to one another so as to enable the two ears (45,45′) to overlap with each other and to align the two fourth through holes (46).

A drive rod (38) is extended through the fourth through holes (46) of the two halves of the abutting device (40A), the second through hole (52), the inner tube (20), the first through hole (34) of the top cap (30), the helical spring (35) and the third through hole (61) to fixedly engage with an inner periphery defining the third through hole (61). The drive rod (38) has a third conical abutting face (37) formed with the drive rod (38) and a block (36) downwardly formed with the third conical abutting face (37) of the drive rod (38) to correspond to the third flange (41).

When the telescopic tube assembly of the present invention is assembled, the top cap (30) and the bottom cap (50) are provided to close the two open ends of the inner tube (20). Then the inner tube (20) is inserted into the outer tube (10) and the drive rod (38) is extended through the fourth through holes (46) of the two halves of the abutting device (40A), the second through hole (52), the inner tube (20), the first through hole (34) of the top cap (30), the helical spring (35) and the third through hole (61) of the stop (60) to fixedly engage with an inner periphery defining the third through hole (61) so that the block (36) abuts an inner face of the third flange (41) with the recoil force providing device (35) sandwiched between the top cap (30) and the stop (60).

With reference to FIGS. 3 and 4, it is noted that when the stop (60) is pressed downward, the third conical abutting face (37) leaves engagement with the second conical abutting face (42) of the abutting device (40A) such that the third flanges (41) of the two halves of the abutting device (40A) do not abut the inner periphery of the outer tube (10) and then the inner tube (20) is able to move freely relative to the outer tube (10). When the stop (60) is released, due to the recoil force from the recoil force providing device (35), the stop (60) is pushed upward relative to the inner tube (20). Because the drive rod (38) is securely and fixedly connected to the stop (60), the upward movement of the stop (60) drives the drive rod (38) to move upward accordingly. Therefore, the third conical abutting face (37) engages with the second conical abutting face (42) of the abutting device (40A). From the abutting force of the third conical abutting face (37), the two halves of the abutting device (40A) move away from each other so that the third flanges (41) of the two halves abut the inner periphery of the outer tube (10) to position the inner tube (20) inside the outer tube (10). Because of the conical structure of the third conical abutting face (37) and the second conical abutting face (42) of the abutting device (40A), the friction force from the inner tube (20) to the outer tube (10) is even and thus the possibility of inclination of the inner tube (20) inside the outer tube (10) is slim. Furthermore, because the abutting force to generate the friction force to position the inner tube (20) in the outer tube (10) is from the movement of the third conical abutting face (37), the helical spring (35), i.e., the recoil force providing device, must provide sufficient force to push the stop (60) upward so that the third conical abutting face (37) abutting the second conical abutting face (42) is able to provide necessary friction force between the third flanges (43) and the inner periphery of the outer tube (10).

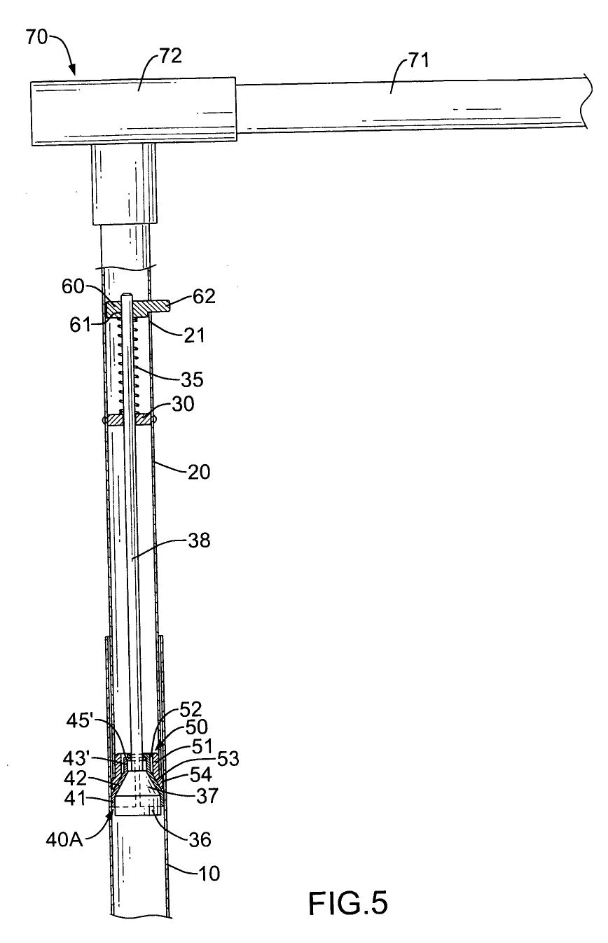

With reference to FIG. 5, when the telescopic tube assembly of the present invention is applied to a clothes rack (70) having a crossbar (71), and a connector (72) respectively provided on two opposed ends of the crossbar (71) for connection with a telescopic tube assembly, the outer tube (10) may have a slit (not numbered) defined through a face thereof to receive therein a finger (62) extending from a periphery of the stop (60) such that the user is able to hold the finger (62) to adjust relative height of the inner tube (20) relative to the outer tube (10). That is, the user is able to hold the finger (62) and press downward the stop (60) to free the inner tube (20) from the outer tube (10). Then because the friction force from the third flanges (41) to the inner face of the outer tube (10) is released, the user is able to freely move the inner tube (20) relative to the outer tube (10) to adjust position of the inner tube (20) as well as the height of the clothes rack (70).

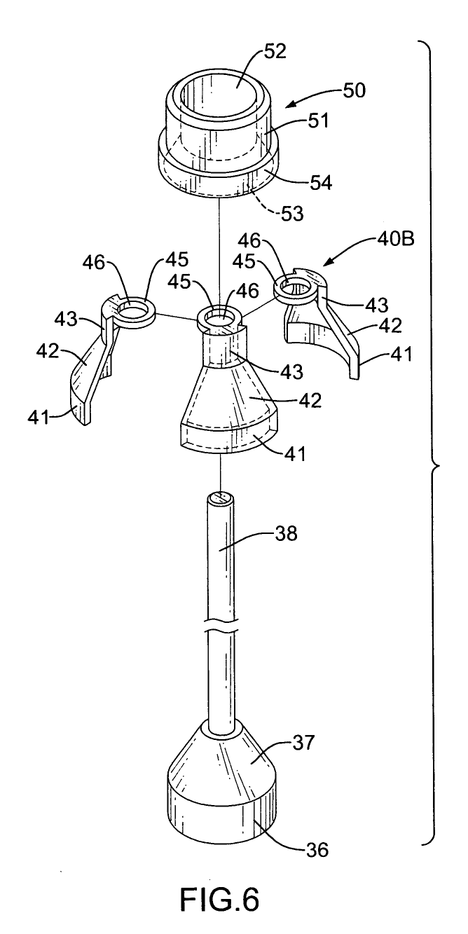

With reference to FIG. 6, the abutting device (40B) in the embodiment is structurally the same as that shown in FIG. 1. The only difference therebetween is that the abutting device (40B) is evenly divided into three pieces. Therefore, the sectorial faces (43) respectively have a height different from the others and thus the ears (45) are respectively located at a position different from the other two ears (45). Accordingly, the third through holes (46) of the three ears (45) are able to align with each other to allow the drive rod (38) to extend therethrough after the three ears (45) are combined. After the extension of the drive rod (38), due to the limitation of the drive rod (38), the three pieces of the abutting device (40B) will expand but will not separate from one another.

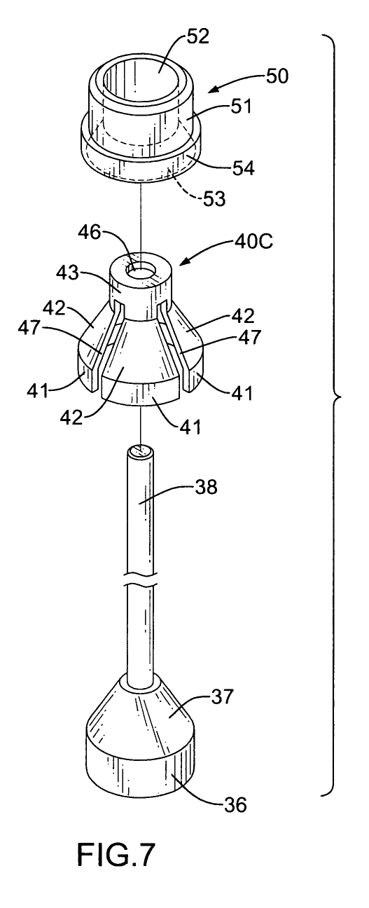

With reference to FIG. 7, it is noted that the abutting device (40C) is structurally the same as that depicted in FIG. 1. The only differences are that the abutting device (40C) is formed as a single piece and has multiple slits (47) defined in the second conical abutting face (42) to allow the second conical abutting face (42) to expand when the third conical abutting face (37) abuts the inner face of the second conical abutting face (42) so as to securely abut the inner periphery of the outer tube (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A telescopic tube assembly comprising:
an outer tube having an open end;
an inner tube having two open ends and slidably received in the outer tube from the open end of the outer tube;
a top cap provided to close one of the two open ends of the inner tube;
a bottom cap provided to close the other one of the two open ends of the inner tube;
an abutting device provided under the bottom cap and having a first flange, a first conical abutting face formed on top of the first flange, a hollow cylinder formed on top of the first conical abutting face, multiple slits defined through the first conical abutting face to evenly divide the first conical abutting face, and a first through hole defined through the hollow cylinder;
a drive rod extending through the first through hole of the abutting device, the bottom cap, the inner tube, the top cap and into a second through hole in a stop to securely engage with a periphery defining the second through hole of the stop and to sandwich a recoil force providing device between the stop and the top cap, the drive rod having a second conical abutting face formed with the drive rod and selectively engaged with the first conical abutting face of the abutting device such that when the stop is moved to place the second conical abutting face at a first position, the second conical abutting face abuts an inner face of the first conical abutting face of the abutting device to expand the divided first conical abutting face evenly and thus a first flange formed with each of the divided first conical abutting faces is able to abut an inner face of the outer tube to position the inner tube inside the outer tube, while the second conical abutting face is placed at a second position due to the movement of the stop, the second conical abutting face of the drive rod leaves the engagement with the first conical abutting face of the abutting device such that the divided first conical abutting face of the abutting device contracts to drive the first flange away from the engagement with the inner periphery of the outer tube so that the outer tube is able to move freely inside the outer tube.

2. The telescopic tube assembly as claimed in claim 1, wherein the bottom cap has a third conical abutting face formed on a bottom face thereof to engage with the first conical abutting face of the abutting device.

3. The telescopic tube assembly as claimed in claim 2, wherein the recoil force providing device is a helical spring.

4. The telescopic tube assembly as claimed in claim 1, wherein there are two slits defined through the first conical abutting face and the hollow cylinder to divide the abutting device into two halves, each half of the abutting device further has an ear formed on top of the hollow cylinder, the two ears formed at different positions relative to one another and having a through hole aligned with one another after the two ears are combined.

5. The telescopic tube assembly as claimed in claim 2, wherein there are two slits defined through the first conical abutting face and the hollow cylinder to divide the abutting device into two halves, each half of the abutting device further has an ear formed on top of the hollow cylinder, the two ears formed at different positions relative to one another and having a through hole aligned with one another after the two ears are combined.

6. The telescopic tube assembly as claimed in claim 1, wherein there are three slits defined through the first conical abutting face and the hollow cylinder to divide the abutting device into three pieces, each piece of the abutting device further has an ear formed on top of the hollow cylinder, the three ears formed at different positions relative to the others and having a through hole aligned with the other through holes after the three ears are combined.

7. The telescopic tube assembly as claimed in claim 2, wherein there are three slits defined through the first conical abutting face and the hollow cylinder to divide the abutting device into three pieces, each piece of the abutting device further has an ear formed on top of the hollow cylinder, the three ears formed at different positions relative to the others and having a through hole aligned with the other through holes after the three ears are combined.

8. The telescopic tube assembly as claimed in claim 3, wherein there are three slits defined through the first conical abutting face and the hollow cylinder to divide the abutting device into three pieces, each piece of the abutting device further has an ear formed on top of the hollow cylinder, the three ears formed at different positions relative to the others and having a through hole aligned with the other through holes after the three ears are combined.

9. The telescopic tube assembly as claimed in claim 4, wherein the recoil force providing device is a helical spring.

10. The telescopic tube assembly as claimed in claim 5, wherein the recoil force providing device is a helical spring.

11. The telescopic tube assembly as claimed in claim 6, wherein the recoil force providing device is a helical spring.

12. The telescopic tube assembly as claimed in claim 7, wherein the recoil force providing device is a helical spring.

13. The telescopic tube assembly as claimed in claim 8, wherein the recoil force providing device is a helical spring.
